(19) United States
(12) Patent Application Publication
(10) Pub. No.: US 2021/0368249 A1
(43) Pub. Date: Nov. 25, 2021

(54) SPEAKER DEVICE AND SPEAKER UNIT

(71) Applicant: TRIGENCE SEMICONDUCTOR, INC., Tokyo (JP)

(72) Inventors: Jun-ichi OKAMURA, Tokyo (JP); Akira YASUDA, Tokyo (JP)

(21) Appl. No.: 16/628,789

(22) PCT Filed: Jun. 7, 2017
(86) PCT No.: PCT/JP2017/021129

§ 371 Date: Jan. 6, 2020

(51) Int. Cl. H04R 1/02; H04R 1/40; H04R 9/02

(52) U.S. Cl. CPC H04R 1/02; H04R 9/02; H04R 1/406

(57) ABSTRACT

A speaker device in one embodiment of the present invention includes a plurality of microphones including at least a first microphone and a second microphone, and a speaker unit including a vibrating surface, a distance between a predetermined position on the vibrating surface and the first microphone being equal to a distance between the predetermined position and the second microphone.

### TECHNICAL FIELD

The present invention is related to a device including a speaker unit.

### BACKGROUND ART

In a speaker device arranged with a microphone, not only are the functions of the microphone and a speaker unit realized, but also functions obtained by linking them. For example, a digital speaker device is disclosed in U.S. Pat. No. 8,423,165 and U.S. Pat. No. 8,306,244 in which ambient noise is canceled by rotating a phase of a sound signal input to a microphone by 180 degrees and outputting from a speaker unit driven by a digital signal. Furthermore, technologies for driving a speaker unit using digital signals are also disclosed in U.S. Pat. No. 9,219,960, U.S. Pat. No. 9,300,310 and U.S. Pat. No. 9,628,928.

### CITATION LIST

### Patent Literature

Patent Document 1: U.S. Pat. No. 8,423,165

Patent Document 2: U.S. Pat. No. 8,306,244

Patent Document 3: U.S. Pat. No. 9,219,960

Patent Document 4: U.S. Pat. No. 9,300,310

Patent Document 5: U.S. Pat. No. 9,628,928

### SUMMARY OF INVENTION

### Technical Problem

As described above, various problems may occur depending on the function which is used in a device which combines a microphone and a speaker unit. In addition, these may sometimes be problems to be solved also in a speaker device which does not use a microphone. One aim of the present invention is to solve at least one of the various problems which occur as described above. Here, an example of a problem is explained in detail.

The first example of a problem to be solved is explained. When utilizing the collecting of sound in a microphone while the sound is being emitted from a speaker unit, the sound from the speaker unit or the vibration for generating the sound may sometimes be included in the sound which is input to the microphone. This sound is added to the sound generated in the periphery of the device and input to the microphone. As a result, there is a problem whereby the sound collecting performance of the microphone is impaired.

The second example of a problem to be solved is explained. A coil for driving a diaphragm of a speaker unit generates a lot of heat since it is driven by a current. There is a problem whereby this heat impairs the sound collecting performance of the microphone. Furthermore, the heat generated in the coil also affects the sound emitting performance of the speaker unit. As a result, the problem according to the second example is also an example of a problem to be solved in a speaker device which does not use a microphone.

In the case when a speaker unit is driven by digital signals, since a circuit for driving the speaker unit can be miniaturized, it is possible to shorten the distance between the speaker unit and the microphone and thus miniaturize the speaker device as a whole. On the other hand, since the effect on the microphone from the speaker unit becomes larger due to miniaturization, the problems described above will become apparent.

### Solution to Problems

According to one embodiment of the present invention, a speaker device is provided including a plurality of microphones including at least a first microphone and a second microphone, and a speaker unit including a vibrating surface, a distance between a predetermined position on the vibrating surface and the first microphone being equal to a distance between the predetermined position and the second microphone.

A vibration surface of the first microphone or a sound collecting port of the first microphone and a vibration surface of the second microphone or a sound collecting port of the second microphone may be arranged substantially on a parallel flat surface respectively.

An angle formed by a vibrating surface of the first microphone and a vibrating surface of the speaker unit maybe 30 degrees or more, and an angle formed by a vibrating surface of the second microphone and a vibrating surface of the speaker unit maybe 30 degrees or more.

An angle formed by a sound collecting port of the first microphone and a vibrating surface of the speaker unit maybe 30 degrees or more, and an angle formed by a sound collecting port of the second microphone and a vibrating surface of the speaker unit maybe 30 degrees or more.

The speaker unit may be stored in an enclosure, and the first microphone and the second microphone may be respectively arranged in a member connected to the enclosure.

A vibrating surface of the speaker unit may include an insulating member and a plurality of metal films arranged in a part of a surface of the insulating member, the speaker unit may include a coil arranged on the vibrating surface, and a terminal of the coil may be electrically connected to the metal film.

The speaker device may furthermore include a signal processing circuit configured to be input with a first sound signal showing an input sound to the first microphone and a second sound signal showing an input sound to the second microphone, configured to execute signal processing using a correlation relationship between the first sound signal and the second sound signal, configured to output a sound collecting signal generated by the signal processing, configured to be input with a third sound signal for driving the speaker unit, and configured to output a drive signal for driving the speaker unit based on the third sound signal.

The signal processing circuit may be configured to be input with a third sound signal for driving the speaker unit, may be configured to output a drive signal for driving the speaker unit based on the third sound signal, and may be configured to output a sound collecting signal by signal processing using the correlation relationship and the third sound signal.

The speaker device may furthermore include an input/output terminal configured to be input with a digital signal and output a digital signal; wherein a third sound signal for driving the speaker unit may be input to the input/output terminal, and the sound collecting signal may be output from the input/output terminal.

The signal processing circuit may include an input buffer configured to temporarily store the third sound signal input from the input/output terminal, and an output buffer configured to temporarily store a sound collecting signal output from the input/output terminal.

The signal processing circuit may include a ΔΣ modulator configured to be input with a third sound signal for driving the speaker unit and configured to modulate a digital signal of n bits, and a filter configured to convert the digital signal of n bits to a plurality of the drive signals.

A vibrating surface of the speaker unit may include an insulating surface and a plurality of metal films arranged in the insulating surface, the speaker unit may include a plurality of coils arranged in the vibrating surface, a terminal of the coil may be electrically connected to the metal film, and each of the plurality of drive signals may be supplied to each coil respectively via the metal film.

The metal film and the terminal of the coil may be electrically connected in an inner periphery side of the coil.

A vibrating surface of the speaker unit may include a heat dissipation film arranged in a position contacting the coil and not contacting the terminal of the coil.

According to one embodiment of the present invention, a speaker unit is provided including a vibrating surface including an insulating surface, a plurality of metal films arranged on the insulating surface, and a coil arranged on the vibrating surface and including a terminal electrically connected to the metal film.

The metal film and the terminal of the coil may be electrically connected in an inner periphery side of the coil.

The vibrating surface may include a heat dissipation film arranged in a position contacting the coil in region other than the terminal of the coil.

A plurality of the coils may be arranged on the vibrating surface.

According to one embodiment of the present invention, a speaker device is provided including a microphone, a speaker unit including a vibrating surface, and a signal processing circuit configured to be input with a third sound signal for driving the speaker unit, configured to output a drive signal for driving the speaker unit based on the third sound signal, configured to be input with a first sound signal showing an input signal to the microphone, and configured to output a sound collecting signal by signal processing using the third sound signal with respect to the first sound signal.

The speaker device may further include an input/output terminal configured to be input with a digital signal and output a digital signal, wherein the third sound signal may be input to the input/output terminal, the sound collecting signal may output from the input/output terminal, the signal processing circuit may include an input buffer configured to temporarily store the third sound signal input from the input/output terminal, and an output buffer configured to temporarily store a sound collecting signal output from the input/output terminal.

According to one embodiment of the present invention, a speaker device is provided including a plurality of microphones including at least a first microphone and a second microphone, and a plurality of speaker units including at least a first speaker unit and a second speaker unit each having a vibrating surface, a distance from the first microphone with respect to a predetermined position between the vibrating surface of the first speaker unit and the vibrating surface of the second speaker unit being equal to a distance from the second microphone with respect to the predetermined position.

The first speaker unit and the second speaker unit may be driven by the same signal.

### Advantageous Effects of Invention

According to one embodiment of the present invention, it is possible to solve at least one of the problems that occur in a device which combines a microphone and a speaker unit.

### BRIEF DESCRIPTION OF DRAWINGS

FIG. 1 is a diagram showing an external view (mounting surface side) of a speaker device in a first embodiment.

FIG. 2 is a diagram showing an external view (sound emitting surface side) of a speaker device in the first embodiment.

FIG. 3 is a schematic diagram showing a cross-sectional structure of a speaker unit in the first embodiment.

FIG. 4 is a diagram showing a vibration member forming a vibrating surface of a speaker unit in the first embodiment.

FIG. 5 is a diagram showing a signal processing circuit in a second embodiment.

FIG. 6 is a diagram showing an external view (sound emitting surface side) of a speaker device in the second embodiment.

FIG. 7 is a diagram showing an external view (sound emitting surface side) of a speaker device in a third embodiment.

FIG. 8 is a diagram showing an external view (sound emitting surface side) of a speaker device in the third embodiment.

FIG. 9 is a diagram showing an external view (sound collecting surface side) of a speaker device in the third embodiment.

FIG. 10 is a diagram for explaining a positional relationship between a speaker unit and a microphone in a speaker device in a fourth embodiment.

FIG. 11 is a diagram for explaining a positional relationship between a speaker unit and a microphone in a speaker device in the fourth embodiment.

FIG. 12 is a diagram showing a vibration member forming a vibrating surface of a speaker unit in a fifth embodiment.

FIG. 13 is a diagram showing a speaker system in a sixth embodiment.

FIG. 14 is a diagram showing a signal processing circuit in a seventh embodiment.

FIG. 15 is a diagram showing an external view (sound emitting surface side) of a speaker device in an eighth embodiment.

FIG. 16 is a diagram showing a signal processing circuit in a ninth embodiment.

### DESCRIPTION OF EMBODIMENTS

The speaker device in one embodiment of the present invention is explained in detail below while referring to the drawings. The plurality of embodiments shown below are an example of an embodiment of the present invention, and the present invention should not to be interpreted as being limited to these embodiments. That is, the present invention can be implemented in various by applying and modifying the known techniques to the plurality of embodiments explained below. Furthermore, in the drawings which are referenced in the drawings, the same reference symbols or similar reference symbols (symbols where only A, B and the like are attached after a numeral) are attached to the same parts or parts having the same function and a repeated explanation may be omitted.

### First Embodiment

### [Overall Structure]

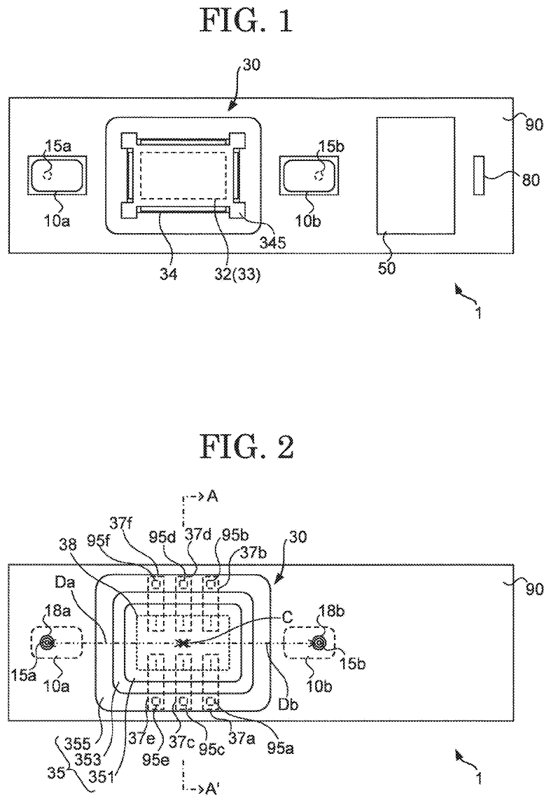

FIG. 1 is a diagram showing an external view (mounting surface side) of a speaker device according to the first embodiment. FIG. 2 is a diagram showing an external view (sound emitting surface side) of the speaker device according to the first embodiment. The speaker device 1 is arranged with two microphones 10a and 10b, a speaker unit 30, a signal processing circuit 50 and a connection terminal 80. In this example, each structure of the speaker device 1 is mounted on a substrate 90. The speaker unit 30 is arranged passing through the substrate 90. The sound emitting surface 90b of the substrate 90 shows a surface on which a vibrating surface 351 of the speaker unit 30 is arranged. A mounting surface 90a of the substrate 90 shows a surface which is opposite to the sound emitting surface 90b. The speaker device 1 carries out predetermined signal processing of sound which is input from the two microphones 10a and 10b in the signal processing circuit 50 and outputs a digital signal from the connection terminal 80. In addition, the speaker device 1 carries out predetermined signal processing of the digital signal input from the connection terminal 80, and drives the speaker unit 30 in order to emit sound. In this example, the speaker unit 30 is driven by three digital signals of “−1”, “0”, and “+1”. The structure of the speaker device 1 is explained in detail below.

### [Microphone]

The microphone 10a is arranged with a vibrating surface 15a. A sound collecting port 18a includes an open part arranged on the sound emitting surface 90b side of the substrate 90, and a duct which extends from the open part to the vibrating surface 15a. When sound which passes through the sound collecting port 18a vibrates the vibrating surface 15a, the microphone 10a outputs an electric signal according to the vibration of the vibrating surface 15a. In this example, it is a digital sound signal Sda which indicates an input sound to the microphone 10a. The microphone 10b is arranged with a vibrating surface 15b. In this example, it is a digital sound signal Sdb which indicates an input sound to the microphone 10b. The sound collecting port 18b includes an open part which is arranged on the sound emitting surface 90b side of the substrate 90, and a duct which extends from the open part to the vibrating surface 15b. When sound which passes through the sound collecting port 18b vibrates the vibrating surface 15b, the microphone 10b outputs an electrical signal according to the vibration of the vibrating surface 15b. In the explanation below, unless otherwise noted, the positions of the sound collecting ports 18a and 18b indicate the positions of the open parts.

The vibrating surface 15a (or the sound collecting port 18a) of the microphone 10a and the vibrating surface 15b (or the sound collecting port 18b) of the microphone 10b are arranged on the same plane. The vibrating surface 15a (or the sound collecting port 18a) of the microphone 10a and the vibrating surface 15b (or the sound collecting port 18b) of the microphone 10b may also be arranged on planes which are substantially parallel to each other, and do not necessarily have to be arranged on the same plane. That is, both the microphone 10a and 10b include sound collecting characteristics which are directed in the same direction.

### [Speaker Unit]

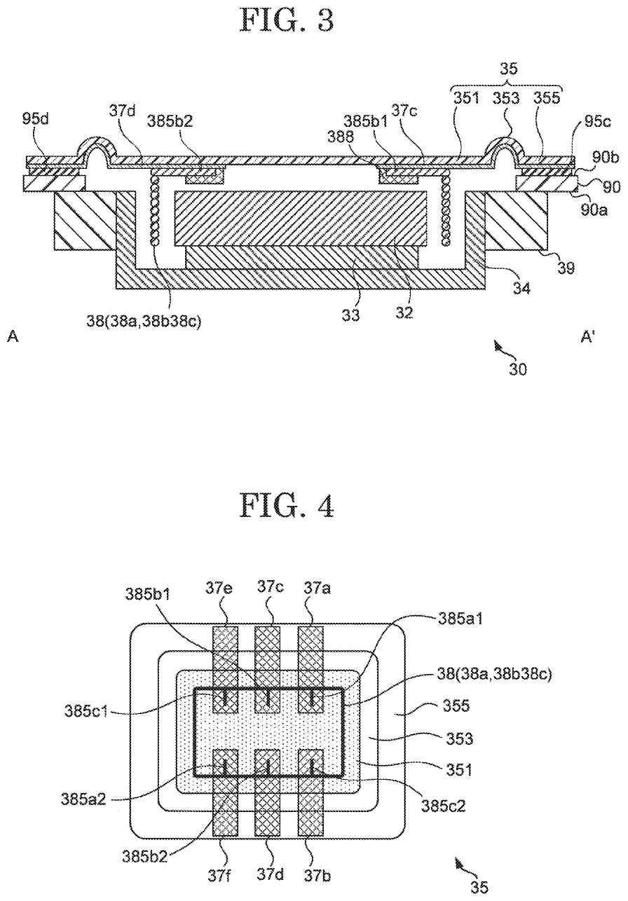

The speaker unit 30 is arranged to pass through the substrate 90 as described above. The vibrating member 35 including the vibrating surface 351 of the speaker unit 30 is connected to the sound emitting surface 90b side of the substrate 90. A yoke 32, a yoke 34 and a magnet 33 of the speaker unit 30 are connected to the mounting surface 90a side of the substrate 90 by the outer periphery part and projecting parts 345 at the four corners of the yoke 34 being supported by a support member 39. An explanation of a detailed structure of the speaker unit 30 is given using FIG. 3 and FIG. 4.

FIG. 3 is a schematic diagram showing a cross-sectional structure of the speaker unit in the first embodiment. FIG. 4 is a diagram showing a vibration member which forms a vibrating surface of the speaker unit in the first embodiment. FIG. 3 is a diagram schematically showing a cross-sectional structure (a fracture surface here) which corresponds to the cross-section line A-A′ in FIG. 2. The vibrating member 35 is a plate shaped insulating member made of a resin. Furthermore, as long as the vibrating member 35 is arranged with an insulating surface at least on the surface where the coil 38 is arranged, then the entire vibrating member does not have to be an insulating member and may partially include a conductive member. The vibrating member 35 includes a vibrating surface 351 (vibrating region) at a center part, a support region 353 which surrounds the periphery of the vibrating surface 351, and a fixed region 355 which surrounds the periphery of the support region 353. Metal films 37a, 37b, 37c, 37d, 37e and 37f (when not distinguished from each other they are referred to below as the metal film 37) are arranged on the surface (insulating surface) of the vibrating member 35 on the substrate 90 side. Although the metal film 37 may be aluminum or copper for example, it may also be a material having conductivity. At this time, it is preferable that the material has a high thermal conductivity. Each of the metal films 37 is arranged spread across the vibrating surface 351, the support region 353 and the fixed region 355.

The fixed region 355 is fixed to the substrate 90 by an adhesive or the like. At this time, terminals 95a, 95b, 95c, 95d, 95e and 95f (when they are not distinguished, they are referred below to as terminals 95) which are arranged on the substrate 90, and the metal films 37a, 37b, 37c, 37d, 37e and 37f are respectively connected to each other. At least the support region 353 of the vibrating member 35 is can bend and deform as a whole. In the present example, the support region 353 can be deformed by including a bending structure. Therefore, even if the fixed region 355 is fixed to the substrate 90, the vibrating surface 351 can be displaced with respect to the substrate 90.

The coil 38 is arranged on the side on of the vibrating surface 351 where the metal film 37 is arranged. In the present example, three coils 38 (when they are distinguished, they are referred below as first coil 38a, second coil 38b and third coil 38c) are bundled together and arranged on the vibrating surface 351. The coil 38 is formed using a wiring material which is covered with an insulator, and the wiring material is exposed at the terminals 385 which are arranged at both ends.

Terminals 385 which are arranged at both ends of the coil 38 are electrically connected to the metal film 37 by a conductive adhesive 388. The terminals 385a1 and 385a2 of a first coil 38a are respectively connected to the metal films 37a and 37f. The terminals 385b1 and 385b2 of a second coil 38b are respectively connected to the metal films 37c and 37d. The terminals 385c1 and 385c2 of a third coil 38c are respectively connected to the metal films 37b and 37e. In addition, in this example, the terminal 385 is arranged on the inner periphery side of the coil 38 and is connected to a region of the vibrating surface 351 of the metal film 37.

When the terminal 385 is arranged on the inner periphery side of the coil 38, there are various advantages than the case where the terminal 385 is arranged on the outer periphery side. For example, adjustment of the exterior dimensions of the coil 38 becomes easier. In addition, it is possible to prevent the coil 38 from being broken when transporting the coil 38 and during manufacturing process of the speaker device using an automatic mounting machine or the like. Furthermore, since the packing size during transportation of the coil 38 can be reduced, this contributes to a reduction in costs. Furthermore, although there are the advantages described, this does not exclude the terminal 385 being arranged on the outer periphery side of the coil 38. In this case, the terminal 385 may be connected to the metal film 37 in a region other than the vibrating surface 351.

Contact is made with the metal film 37 in a region other than the terminal 385 of the coil 38. Since parts other than the terminal 385 of the coil 38 are covered by an insulator, the coil 38 and the metal film 37 are in contact via an insulator in this region. Therefore, it is possible to dissipate heat which is generated by the coil 38 from the region other than the terminal 385 via the metal film 37. Since the metal film 37 is also connected to the substrate 90 via the terminals 95, heat can also be dissipated via wiring arranged on the substrate 90.

Since the metal film 37 is a thin film formed on the vibrating member 35 using a vapor deposition method or plating method which can be used even in a semiconductor process or the like, it is possible to form the metal film 37 to a thickness of about 2 to 10 μm compared to a 60-80 pm wiring material which is used in a normal speaker unit. In addition, since the width and thickness of the metal film 37 can be easily adjusted at the time of formation, it is possible to easily adjust the resistance value and the heat capacity (heat radiation amount).

In addition, since the terminal 385 of the coil 38 is connected to the metal film 37 which is arranged on the vibrating surface 351, the entire coil 38 including the terminal 385 moves together with the vibrating surface 351. In the case when the terminal 385 of the coil 38 is connected to a part other than the vibrating surface 351, in particular to a member different from the vibrating member 35, the shape of the wiring material of the coil 38 continues to change together with the vibration of the vibrating surface 351. That is, a large mechanical stress is applied to the wiring material of the coil 38. In the case when the metal film 37 is used, mechanical stress occurs on the metal film 37 due to the vibration of the vibrating surface 351. On the other hand, it is resistant to mechanical stress because of the characteristic of a thin film shape formed along the surface of the vibrating member 35. In addition, the resistance to stress is further improved by appropriately selecting the type and thickness of the metal. In this way, the reliability of the speaker device 1 is also improved. Furthermore, although there are the advantages described above, the terminal 385 may also be connected to a conductor which is arranged other than on the vibrating surface 351 (for example, the substrate 90).

The yoke 32 and the yoke 34 are connected to the magnet 33 and arranged so as to sandwich the coil 38 by a reverse polarity. Therefore, the coil 38 which is arranged in the magnetic field which is formed by the yokes 32 and 34 generates a drive force which corresponds to a signal (the three digital signals described above) which is supplied via the metal film 37, and the vibrating surface 351 of the vibrating member 35 is moved (vibrated) by this drive force.

### [Positional Relationship Between Microphone and Speaker Unit]

The positional relationship between the microphones 10a and 10b and the speaker unit 30 is explained by returning to FIG. 2. In the speaker device 1, a distance Da between the predetermined position C on the vibrating surface 351 of the speaker unit 30 and the microphone 10a (specifically, the vibrating surface 15a or the sound collecting port 18a), and the distance Db between the position C and the microphone 10b (specifically, the vibration surface 15b or the sound collecting port 18b) are equal. The predetermined position C may be any position of the vibrating surface 351, and in this example, it is the center of gravity of the vibrating surface 351. In addition, although the predetermined position C is arranged on a straight line which connects the sound collecting port 18a and the sound collecting port 18b in this example, it does not have to be arranged on this straight line. In addition, the entire speaker unit 30 does not need to be arranged on the straight line. For example, the microphones 10a and 10b may also be arranged on the same side with respect to the speaker unit 30. Furthermore, an example of such a structure is also explained in the third embodiment.

### [Signal Processing Circuit]

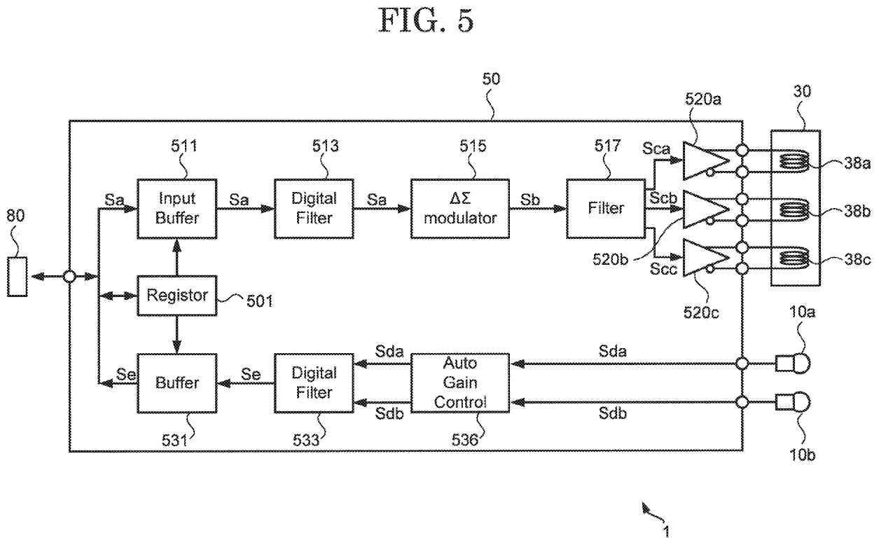

Next, the signal processing circuit 50 is explained. The signal processing circuit 50 is formed as an integrated circuit using a semiconductor element, performs predetermined signal processing with respect to sound input from the microphones 10a and 10b and outputs sound to the connection terminal 80 as a digital signal. In addition, the signal processing circuit 50 performs predetermined signal processing with respect to a digital signal input from the connection terminal 80, and outputs a three-value digital signal described above to the coil 38. In this way, it can be said that the connection terminal 80 is an input/output terminal which inputs and outputs digital signals. The structure of the signal processing circuit 50 is explained using FIG. 5.

FIG. 5 is a diagram showing a signal processing circuit in the first embodiment. The signal processing circuit 50 is arranged with a register circuit 501, an input buffer 511, a speaker digital filter 513, a ΔΣ modulator 515, a post filter 517, drive circuits 520 (drive circuits 520a, 520b, 520c), an output buffer 531, a microphone digital filter 533 and an automatic gain control circuit 536.

The input buffer 511 is a buffer for temporarily storing a digital sound signal Sa which is input from the connection terminal 80, and its operation (output timing to the speaker digital filter 513 and the like) is controlled by a signal from the register circuit 501. The speaker digital filter 513 obtains the digital sound signal Sa which is output from the input buffer 511, performs predetermined filter processing with respect to the digital sound signal Sa and outputs the digital sound signal Sa. The ΔΣ modulator 515 obtains the digital sound signal Sa which is output from the speaker digital filter 513, performs ΔΣ modulation on the digital sound signal Sa and outputs an n-bit digital modulation signal Sb. The post filter 517 obtains the digital modulation signal Sb which is output from the ΔΣ modulator 515 and converts the signal into k drive signals Sc (drive signals Sca, Scb and Scc in this example) which correspond to the digital modulation signal Sb and outputs the signals. As described above, in this example, the drive signal Sc is a three-value digital signal of “−1”, “0” and “+1”. K drive circuits 520 (drive circuits 520a, 520b and 520c in this example) obtain the drive signals Sca, Scb and Scc and s coils 38 (first coil 38a, second coil 38b and third coil 38c in this example) is driven according to the drive signals Sca, Scb and Scc.

Among the signal processing circuits 50, processing in order to drive a speaker unit by a plurality of coils, for example, processing by the ΔΣ modulator 515 and the post filter 517 may be realized by known techniques. As the known techniques, for example, detailed processes are disclosed in U.S. Pat. No. 8,423,165, U.S. Pat. No. 8,306,244, U.S. Pat. No. 9,219,960 and U.S. Pat. No. 9,300,310. According to these techniques, noise shaping performed by a ΔΣ modulator and mismatch shaping performed by a post filter are used. Furthermore, mismatch shaping is a technique in which a coil which distributes drive signals in order to reduce variations is selected.

The automatic gain control circuit 536 obtains digital sound signals Sda and Sdb which are output from the microphones 10a and 10b, performs automatic gain control with respect to the digital sound signals Sda and Sdb, and outputs the signals. At this time, it is preferred that the same gain control is performed with respect to the digital sound signals Sda and Sdb.

The microphone digital filter 533 obtains the digital sound signals Sda and Sdb which are output from the automatic gain control circuit 536, performs predetermined filter processing, and outputs a digital sound collecting signal Se. In this example, the digital sound collecting signal Se is obtained by performing signal processing by utilizing a correlation between the digital sound signal Sda and the digital sound signal Sdb. Specifically, the digital sound signal Sda is obtained by synthesizing the digital sound signal Sda and the digital sound signal Sdb and removing an in-phase component of the digital sound signal Sda and the digital sound signal Sdb. Furthermore, the digital sound collecting signal Se may be obtained by removing the in-phase component from the digital sound signal Sda or the digital sound signal Sdb.

The microphones 10a and 10b and the speaker unit 30 have the positional relationship described above. As a result, when sound emission from the speaker unit 30 and sound collecting by the microphones 10a and 10b are performed during the same time period, vibration of the vibrating surface 351 of the speaker unit 30 or sound according to sound vibration is input to the microphones 10a and 10b almost at the same time. Furthermore, the majority of the sound is input to the microphones 10a and 10b via the air. On the other hand, a part of the vibration of the vibration surface 351 is propagated through the substrate 90 or housing (for example, see FIG. 11), and is input to the microphones 10a and 10b.

In either case, components (sound, vibration) which are caused by vibration of the vibrating surface 351 are included as in-phase components in the digital sound signals Sda and Sdb. As described above, in the microphone digital filter 533 the in-phase component of the digital sound signals Sda and Sdb is removed whereby the components caused by the vibration of the vibrating surface 351 input to the microphones 10a and 10b are removed, and it is possible to extract the sound which is input to the microphones 10a and 10b from the digital sound signals Sda and Sdb in a state where there is no sound emission from the unit 30.

In the case when the distance between a sound source and the microphone 10a is different from the distance between a sound source and the microphone 10b, it is possible to distinguish the in-phase components described above since the digital sound signals Sda and Sdb have different phase components. On the other hand, the sound which is generated from the sound source positioned at an equal distance from the microphone 10a and the microphone 10b is similarly included as an in-phase component in the digital sound signal Sda and Sdb. As a result, although it is attenuated by the process described above, since the sound source is generally not as strictly determined as much as the positional relationship between the speaker unit 30 and the microphones 10a and 10b, in any cases it remains as a component to a certain degree. In addition, since a system is usually formed so that the plurality of speaker devices 1 are in a stereo arrangement, the sound which is generated from the sound source in any one of the plurality of speaker devices 1 remains as a different phase component of the digital sound signal Sda and Sdb. Therefore, it is possible to avoid attenuation due to the process described above by using the digital sound collecting signal Se of any one of the plurality of speaker devices 1.

The output buffer 531 is a buffer for temporarily storing the digital sound collecting signal Se which is output from the microphone digital filter 533, and the operation (output timing to the connection terminal 80 and the like) is controlled by a signal from the register circuit 501. In this example, since the signal processing circuit 50 includes the input buffer 511 and the output buffer 531, bi-directional communication is possible using the same communication path with an external device such as the system described above which is connected via the connection terminal 80.

The speaker device 1 was in the first embodiment was explained above. Next, a speaker device in another embodiment is explained. Furthermore, in each embodiment, an explanation of the structure having the same function as in other embodiments is omitted and different structures are mainly explained.

### Second Embodiment

In the first embodiment, the speaker device 1 in which one speaker unit 30 was used for the two microphones 10a and 10b was explained. In the second embodiment, a speaker device 1A in which two speaker units 30 (speaker unit 30a and speaker unit 30b) are used is explained.

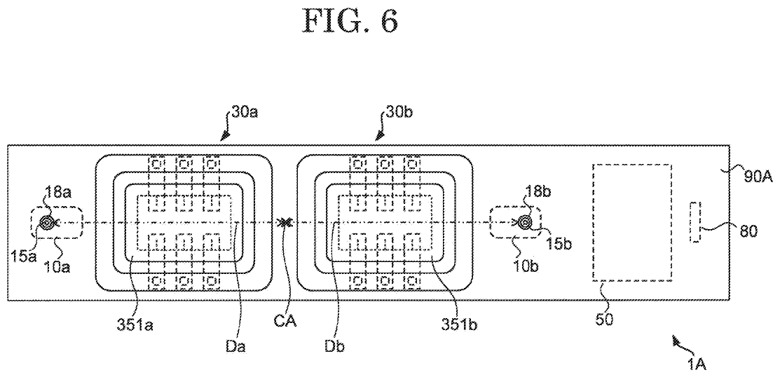

FIG. 6 is a diagram showing an external view (sound emitting surface side) of a speaker device in the second embodiment. As is shown in FIG. 6, speaker units 30a and 30b are arranged between the microphone 10a and the microphone 10b in the substrate 90A. In this example, the speaker units 30a and 30b are driven by the same digital sound signal Sa. That is, the coil 38 of the speaker unit 30a and the coil 38 of the speaker unit 30b are supplied and driven by the same drive signal.

In this way, in the case when two speaker units 30a and 30b are arranged, each positional relationship of speaker unit 30a, 30b and the microphones 10a, 10b is the positional relationship which satisfies the conditions below. A distance Da between a predetermined position CA between each vibrating surface 351a and 351b and the microphone 10a (specifically, the vibrating surface 15a or the sound collecting port 18a), and a distance Db between the position CA and the microphone 10b (specifically, the vibrating surface 15b or the sound collecting port 18b) are equal. The predetermined position CA may be any position between the vibrating surface 351a and the vibrating surface 351b. In this example, the predetermined position CA is the center of gravity arrangement of the speaker units 30a and 30b, and corresponds to the middle point of a straight line which connects the center of gravity of the vibrating surface 351a and the center of gravity of the vibration surface 351b.

By defining the positional relationship between the speaker units 30a and 30b and the microphones 10a and 10b as described above, it is possible to treat the digital sound signals Sda and Sdb which are output from the microphones 10a and 10b almost the same as in the first embodiment.

### Third Embodiment

In the first embodiment, the microphones 10a and 10b are arranged on the substrate 90. In the third embodiment, a speaker device 1B in which the microphones 10a and 10b are arranged on a support plate which is connected to the substrate 90 is explained.

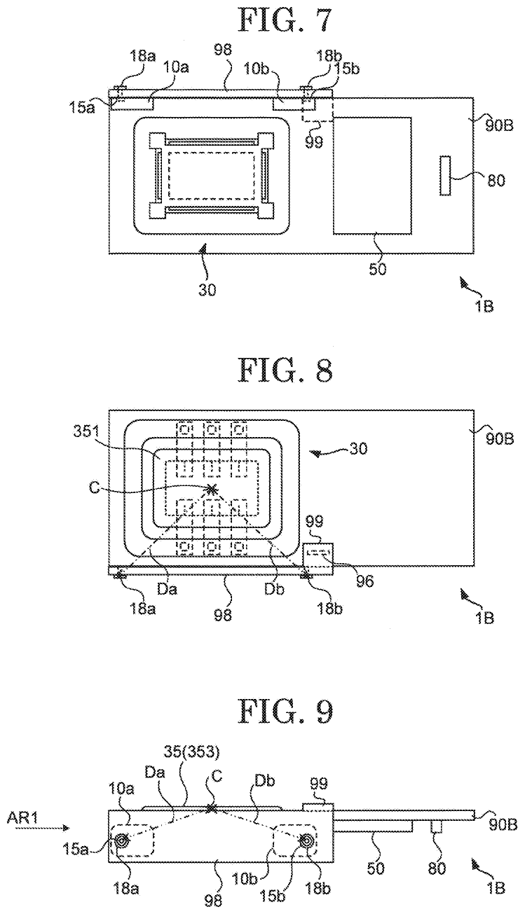

FIG. 7 is a diagram showing an external view (mounting surface side) of the speaker device in the third embodiment. FIG. 8 is a diagram showing an external view (sound emitting surface side) of the speaker device in the third embodiment. FIG. 9 is a diagram showing an external view (sound collecting surface side) of the speaker device in the third embodiment. The speaker device 1B is arranged with a support plate 98 on the side surface of the substrate 90B. The support plate 98 includes a connection region 99 which is formed partially curved. The support plate 98 is fixed to the substrate 90B via the connection region 99. In the connection region 99, terminals are arranged for electrically connecting the microphones 10a and 10b and the signal processing circuit 50 by electrically connecting to a terminal 96 of the substrate 90B.

The microphones 10a and 10b are arranged on the speaker unit 30 side of the support plate 98. In the present example, the sound collecting ports 18a and 18b are arranged on the opposite side to the speaker unit 30. The sound collecting port 18a and the vibrating surface 15a are connected via a duct which passes through the support plate 98. The sound collecting port 18b and the vibrating surface 15b are connected via a duct which passes through the support plate 98.

In the present example, the microphones 10a and 10b are both arranged on the same side with respect to the speaker unit 30. On the other hand, similar to the first embodiment, the distance Da between a predetermined position C on the vibrating surface 351 and the microphone 10a (specifically, the vibrating surface 15a or the sound collecting port 18a) and the distance Db between the position C and the microphone 10b (specifically, the vibrating surface 15b or the sound collecting port 18b) are equal.

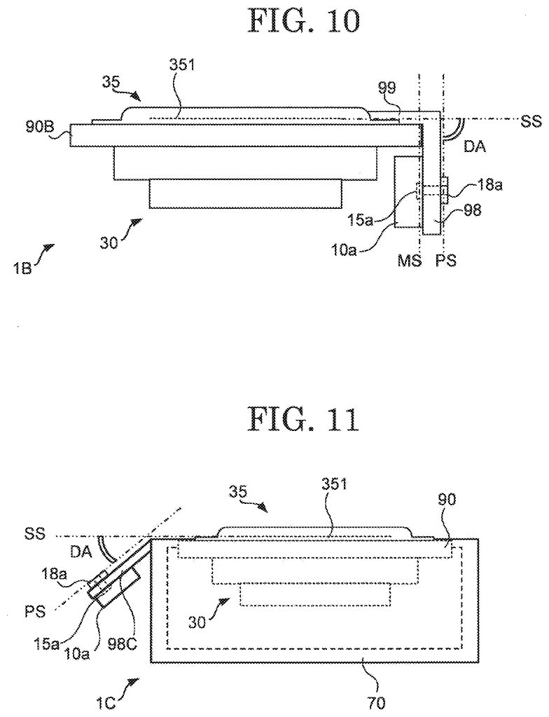

FIG. 10 is a diagram for explaining the positional relationship between the speaker unit and the microphone in the speaker device in the third embodiment. FIG. 10 is a schematic diagram showing the speaker device 1B seen along the direction AR1 in FIG. 9. An angle DA between a virtual plane SS along the vibrating surface 351 and a virtual plane PS along the sound collecting port 18a (or a virtual plane MS along the vibrating surface 15a) is 90 degrees in the present example. Here, when the vibrating surface 351 of the speaker unit 30 vibrates, the vibration is transmitted as the vibration of air. That is, most of the components in the vibration direction of air are in the vibration direction of the vibrating surface 351. By arranging the microphones 10a and 10b and the speaker unit 30 in this positional relationship, it is difficult to transmit vibrations of air having different vibration directions to the sound collecting port 18a (or the vibrating surface 15a) of the microphone 10a. The same is true for the microphone 10b.

Furthermore, although the angle DA is 90 degrees in the present example, it may also be less than 90 degrees. In the case of 0 degrees, the arrangement example is the same as the microphones 10a and 10b in the first embodiment. In the case where the structure exemplified in the third embodiment is adopted, the angle DA is preferably 30 degrees or more and 90 degrees or less, and more preferably 45 degrees or more and 90 degrees or less. In this way, the vibration of air according to the vibration of the vibrating surface 351 can make it difficult to be transmitted as the vibration of the vibrating surfaces 15a and 15b.

### Fourth Embodiment

In the third embodiment, the support plate 98 which is arranged with the microphones 10a and 10b is connected to the substrate 90. In the fourth embodiment, a speaker device 1C is explained in which a support plate arranged with the microphones 10a and 10b is connected to a speaker enclosure.

FIG. 11 is a diagram for explaining the positional relationship between a speaker unit and a microphone in the speaker device in the fourth embodiment. The speaker device 1C is arranged with a speaker enclosure 70 (housing) which stores the speaker unit 30. In the present example, the vibrating member 35 is exposed from the speaker enclosure 70. A support plate 98C is connected to an end of the speaker enclosure 70. Similar to the support plate 98 in the third embodiment, the microphones 10a and 10b are arranged on the support plate 98C. In this way, even when the support plate 98C is connected via the speaker enclosure 70, there is no significant difference from the case where the support plate 98C is connected to the substrate 90B in the third embodiment. Therefore, also in this case, similar to the third embodiment, the angle DA based on the virtual plane SS is preferred to be 30 degrees or more and 90 degrees or less, and more preferably 45 degrees or more and 90 degrees or less.

Furthermore, the vibration of the vibrating surface 351 may also be transmitted to the speaker enclosure 70. Therefore, instead of the virtual plane SS, it is preferred that the angle DA which is based on any of the surfaces of the speaker enclosure 70 is larger than 0 degrees, and it is more preferable that the angle is 30 degrees or more. In addition, it is more preferable that a plurality of surfaces which satisfy these conditions exist.

### Fifth Embodiment

In the fifth embodiment, a structure is explained in which the heat dissipation effects of the vibrating member 35 in the first embodiment are further increased.

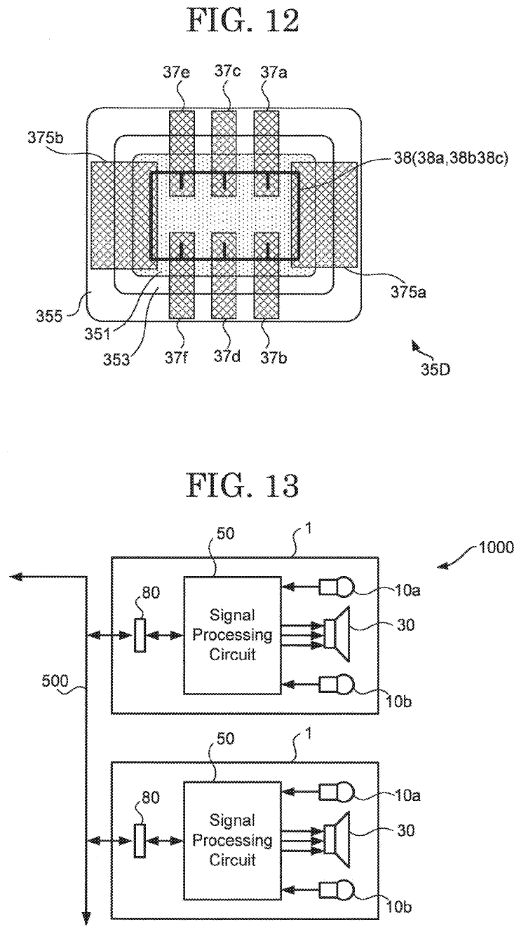

FIG. 12 is a diagram showing a vibration member which forms a vibration surface of a speaker unit in the fifth embodiment. The vibrating member 35D is further arranged with heat dissipation films 375a and 375b with respect to the vibrating member 35 in the first embodiment. In the present example, the heat dissipation films 375a and 375b are formed with the same material as the metal film 37. Similar to the metal film 37, the heat dissipation films 375a and 375b are arranged so as to spread across the vibrating surface 351, the support region 353 and the fixing region 355.

The heat dissipation films 375a and 375b contact the coil 38 on the vibrating surface 351. As is described above, since an insulator is arranged on the surface of a wiring material of the coil 38 other than the terminal 385, the heat dissipation films 375a and 375b and the coil 38 are electrically insulated. On the other hand, heat generated by the coil 38 is transmitted to the heat dissipation films 375a and 375b. Since the heat dissipation films 375a and 375b are in contact with the substrate 90, heat can be dissipated via the substrate 90. When a metal film for heat dissipation arranged on the substrate 90 corresponds to the position where the heat dissipation films 375a and 375b are arranged, it is possible to further increase the heat dissipation effects.

### Sixth Embodiment

In the sixth embodiment, an example of a speaker system is explained in which a plurality of speaker devices (speaker device 1 in the first embodiment in the present example) in each embodiment described above are connected to the same communication path. For example, by using two speaker devices 1 as a Lch speaker device and a Rch speaker device, it is possible to use them as a stereo speaker system.

FIG. 13 is a diagram showing a speaker system in the sixth embodiment. The speaker system 1000 is arranged with a plurality of speaker devices 1. The plurality of speaker devices 1 are all connected to the same communication path 500 and can communicate bi-directionally with the host system described above. As is described above, it is possible to realize such a structure since the signal processing circuit 50 in each speaker device 1 is arranged with the input buffer 511 and the output buffer 531. In addition, it is possible to synchronize each device using such a structure. Furthermore, the communication path 500 may be wired communication or wireless communication.

### Seventh Embodiment

In the seventh embodiment, a speaker device 1E is explained arranged with a signal processing circuit 50E which uses a digital signal processor instead of the speaker digital filter 513 and the microphone digital filter 533 in the signal processing circuit 50 in the first embodiment.

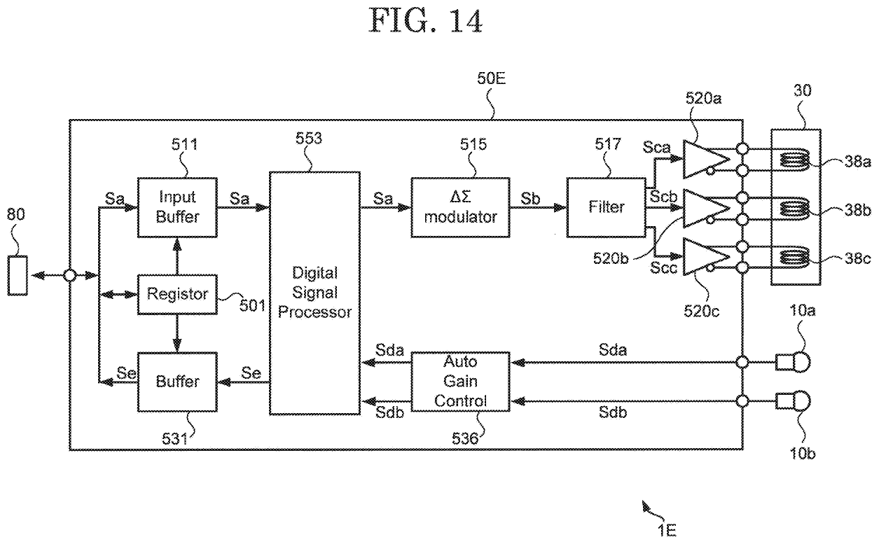

FIG. 14 is a diagram showing a signal processing circuit in the seventh embodiment. In the signal processing circuit 50E, a digital signal processor 553 is used instead of the speaker digital filter 513 and the microphone digital filter 533 of the signal processing circuit 50 in the first embodiment. By adopting such a structure, not only is signal processing realized in the speaker digital filter 513 and the microphone digital filter 533 but it is also possible to perform more complicated signal processing.

### Eighth Embodiment

In the eighth embodiment, although the microphones 10a and 10b and the speaker units 30a and 30b are used as in the second embodiment, a speaker device 1F which has a different positional relationship is explained.

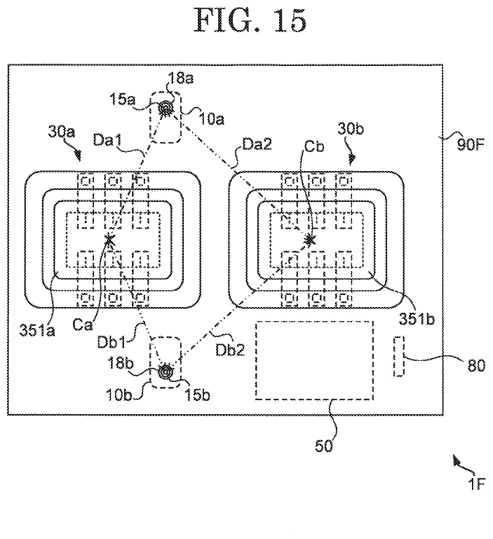

FIG. 15 is a diagram showing an external view (sound emitting surface side) of a speaker device in the eighth embodiment. Compared with the speaker device 1A in the second embodiment, the speaker device 1F is arranged with the microphones 10a and 10b, the speaker units 30a and 30b which are arranged in a different positional relationship in the substrate 90F.

The positional relationship between the microphones 10a and 10b and the speaker units 30a and 30b in the speaker device 1F is explained. A distance Da1 between a predetermined position Ca on the vibrating surface 351a of the speaker unit 30a and the microphone 10a (specifically, the vibrating surface 15a or the sound collecting port 18a) and the distance Db1 between the position Ca and the microphone 10b (specifically, the vibrating surface 15b or the sound collecting port 18b) are equal. In addition, a distance Da2 between a predetermined position Cb on the vibration surface 351b of the speaker unit 30b and the microphone 10a (specifically, the vibration surface 15a or the sound collecting port 18a) and a distance Db2 between the position Ca and the microphone 10b (specifically, the vibration surface 15b or the sound port 18b) are equal.

That is, in the case where the speaker units 30a and 30b are present as in the second embodiment, it can be said that the positional relationship satisfies the conditions in the first embodiment is satisfied in the relationship between each speaker unit and the microphones 10a and 10b. In this case, even if the signal for driving the speaker unit 30a and the signal for driving the speaker unit 30b are different, the sound or vibration from any one of them is input to the microphones 10a and 10b as the in-phase component.

Furthermore, in the case when a signal for driving the speaker unit 30a and a signal for driving the speaker unit 30b are the same, the distance Da1 and the distance Db2 may be equal and the distance Da2 and the distance Db1 may be equal.

### Ninth Embodiment

In the first embodiment, the microphone digital filter 533 of the signal processing circuit 50 generated the digital sound collecting signal Se by removing the in-phase component of the digital sound signal Sda and the digital sound signal Sdb. In the ninth embodiment, a signal processing circuit 50G is explained in which a component caused by vibration of the vibrating surface 351 is removed from at least one of the digital sound signal Sda and the digital sound signal Sdb.

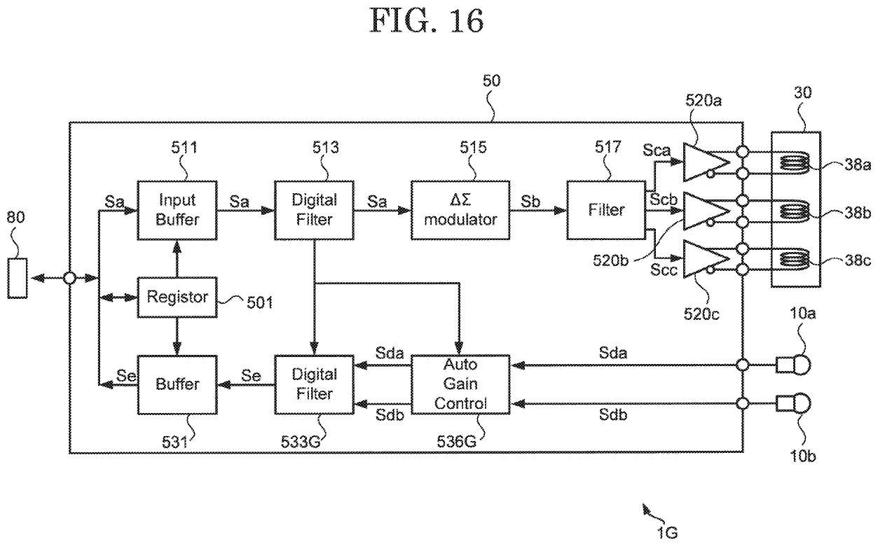

FIG. 16 is a diagram showing a signal processing circuit in the ninth embodiment. Compared with the signal processing circuit 50 in the first embodiment, the signal processing circuit 50G is arranged with a microphone digital filter 533G and an automatic gain control circuit 536G instead of the microphone digital filter 533 and the automatic gain control circuit 536.

The automatic gain control circuit 536G performs automatic gain control with respect to the digital sound signal Sda and the digital sound signal Sd and outputs the result. At this time, the automatic gain control circuit 536G uses the digital sound signal Sa which is output from the speaker digital filter 513 and adjusts the gain according to the size (volume) of the signal. For example, the gain is set small when the volume of the digital sound signal Sa is large. This process may be applied to the signal processing circuit in each embodiment described above.

The microphone digital filter 533G obtains at least one of the digital sound signals Sda and Sdb which are output from the automatic gain control circuit 536G, performs a predetermined filtering process, and outputs a digital sound collecting signal Se. In the present example, the digital sound collecting signal Se is obtained by performing signal processing on at least one of the digital sound signal Sda and the digital sound signal Sdb by utilizing the digital sound signal Sa output from the speaker digital filter 513. Specifically, a component of the digital sound signal Sa is removed from at least one of the digital sound signal Sda and the digital sound signal Sdb using the digital sound signal Sa. Here, at least one component of the digital sound signal Sda and the digital sound signal Sdb is defined as an observation signal Y, a component originally desired to be observed by the microphones 10a and 10b is defined as a sound signal S, a component output from the speaker unit 30 is defined as a sound signal X, and a sneaking sound from the speaker unit 30 to the microphones 10a and 10b and the influence of vibration are defined as a coefficient C. In this case, it can be represented by the filter notation of S=(Y−CX). However, it is assumed that the processing is carried out on the frequency axis. By calculating the coefficient C in advance or adaptively, it is possible to obtain the sound signal S (corresponding to the digital sound collecting signal Se) by a filtering process from the observation signal Y (corresponding to the digital sound signals Sda and Sdb) and the sound signal X (corresponding to the digital sound signal Sa which is output from the speaker digital filter 513).

As described above, in the microphone digital filter 533G, since it is sufficient that there is one of the digital sound signals Sda and Sdb, only one of the microphones 10a and 10b need to be present. That is, a structure may be adopted using one microphone. In the case where both of the digital sound signals Sda and Sdb are used, a process may be performed whereby the component of the digital sound signal Sa is further removed from the digital sound collecting signal Se which is obtained in the microphone digital filter 533 in the first embodiment.

Furthermore, although omitted from the diagram, similar to the seventh embodiment, it is possible to replace the speaker digital filter 513 and the microphone digital filter 533G with a digital signal processor. In this way, it is possible to more adaptively calculate the coefficient C.

### MODIFIED EXAMPLE

As described above, although one embodiment of the present invention was explained, each embodiment described above can be applied in combination or mutually substituted. In addition, in each embodiment described above, it is also possible to implement the invention by transforming as follows.
(1) The speaker device in each embodiment described above can be used in a personal computer, a television, a smartphone and a tablet computer and the like. In particular, the speaker device is effective in a system which operates a computer by speech recognition. For example, in a television in which stations can be switch by speech recognition, speech recognition has not been properly carried out unless conventionally the sound of the television has been stopped or the volume has been reduced. According to the speaker device in each embodiment of the present invention, it is possible to generate the digital sound collecting signal Se from which a user's voice is appropriately extracted even in a state where the sound of the television is continuously output. Therefore, speech recognition is properly processed. Furthermore, it is preferred to appropriately arrange the position of a speaker device so that a position which usually can be a sound source such as the front direction of a television is not an equal distance from each microphone 10a and 10b.
(2) The speaker device in each of embodiment described above can also be used as a communication device using ultrasonic waves. Communication between two speaker devices by ultrasonic waves is possible by generating ultrasonic waves by vibrating a vibrating surface in the speaker unit at a frequency above the audible range (for example, 20 kHz to 100 kHz) and using a microphone which can be input with ultrasonic waves in this frequency band. According to the digital speaker, driving can be easily performed in such a frequency band.
(3) According to each embodiment described above, it is possible to perform a self-test by using a microphone and a signal processing circuit in a speaker device such as a characteristic test and a noise test of the speaker unit in a manufacturing line. As a result, it is possible to economize on investments in test equipment on the production line. In addition, each customer can automatically adjust and customize the frequency characteristics of a speaker.
(4) By mounting a digital linear corrector as is disclosed in U.S. Pat. No. 9,628,928 to the speaker device in each embodiment described above, it is possible to calculate an inverse function F−1 (IN) which is necessary to correct non-linearity in a speaker unit by utilizing a signal from the microphone.
(5) In each embodiment described above, the microphones 10a and 10b are facing in the same direction. That is, although the vibrating surfaces 15a and 15b (sound collecting ports 18a and 18b) are arranged on the same plane (orientation directions are substantially the same), the present invention is not limited to this arrangement. For example, the vibrating surface 15a and the vibrating surface 15b may have a predetermined angle. However, it is preferable that the arrangement has symmetry with respect to the predetermined position C.
(6) In each embodiment described above, although the number of speaker units is one or two, it may also be three or more.
(7) In each embodiment described above, although the number of microphones is one or two, it may also be three or more.
(8) In each embodiment described above, although a speaker unit is a digital speaker unit driven by a digital signal, the present invention is not limited to this speaker unit. For example, the speaker unit may include voice coils which are supplied with an analog signal. In this case, the signal processing circuit is preferred to be arranged with a circuit for driving a voice coil using an analog signal.
(9) In each embodiment described above, although the vibrating surface of a microphone and an open part of a sound collecting port are parallel, they do not have to be parallel by using a curved duct part.
(10) In each embodiment described above, although a microphone is mounted in a speaker device, a speaker device which does not use a microphone is also possible.
(11) In each embodiment described above, although the vibrating member 35 which is arranged with the metal film 37 on the vibrating surface 351 is arranged in a speaker unit, the present invention is not limited to the use of this type of vibrating member 35. For example, a generally known speaker unit may also be used.
(12) In each embodiment described above, the vibrating surface 15a (or the sound collecting port 18a) of the microphone 10a and the vibrating surface 15b (or the sound collecting port 18b) of the microphone 10b may be arranged on planes which intersects with each other. That is, the microphones 10a and 10b may have sound collecting characteristics directed in different directions.
(13) In each embodiment described above, although the speaker unit used a vibration actuator by a coil and a magnet, the present invention is not limited to a speaker unit using a vibration actuator. For example, known speaker units which use a general piezoelectric actuator or an electrostatic actuator may also be used.

### REFERENCE SIGNS LIST

1, 1A, 1B, 1C, 1E, 1F . . . speaker device, 10a, 10b . . . microphone, 15a, 15b . . . vibrating surface, 18a18b . . . sound collecting port, 30, 30a, 30b . . . speaker unit, 32 . . . yoke, 33 . . . magnet, 34 . . . yoke, 35, 35D . . . vibrating member, 37, 37a, 37b, 37c, 37d, 37e, 37f . . . metal film, 38 . . . coil, 38a . . . first coil, 38b . . . second coil, 38c . . . third coil, 39 . . . support member, 50, 50E, 50G . . . signal processing circuit, 70 . . . speaker enclosure, 80 . . . connection terminal, 90, 90A, 90B, 90F . . . substrate, 90a . . . mounting surface, 90b . . . sound emitting surface, 95, 95a, 95b, 95c, 95d, 95e, 95f . . . terminal, 96 . . . terminal, 98, 98C . . . support plate, 99 . . . connection region, 345 . . . projecting part, 351, 351a, 351b . . . vibrating surface, 353 . . . support region, 355 . . . fixed region, 375a, 375b . . . heat dissipation film, 385, 385a1, 385a2, 385b1, 385b2, 385c1, 385c2 . . . terminal, 388 . . . conductive adhesive, 500 . . . communication path, 501 . . . register circuit, 511 . . . input buffer, 513 . . . speaker digital filter, 515 . . . ΔΣ modulator, 517 . . . post filter, 520, 520a, 520b, 520c . . . drive circuit, 531 . . . output buffer, 533, 533G . . . microphone digital filter, 536, 536G . . . automatic gain control circuit, 553 . . . digital signal processor, 1000 . . . speaker system

1. A speaker device comprising:
a plurality of microphones including at least a first microphone and a second microphone; and
a speaker unit including a vibrating surface, a distance between a predetermined position on the vibrating surface and the first microphone being equal to a distance between the predetermined position and the second microphone.

2. The speaker device according to claim 1, wherein
a vibration surface of the first microphone or a sound collecting port of the first microphone is arranged on a first surface,
a vibration surface of the second microphone or a sound collecting port of the second microphone is arranged on a second surface, and
the first surface and the second surface are substantially parallel to each other.

3. The speaker device according to claim 1, wherein
an angle formed by a vibrating surface of the first microphone and a vibrating surface of the speaker unit is 30 degrees or more, and
an angle formed by a vibrating surface of the second microphone and a vibrating surface of the speaker unit is 30 degrees or more.

4. The speaker device according to claim 1, wherein
an angle formed by a sound collecting port of the first microphone and a vibrating surface of the speaker unit is 30 degrees or more, and
an angle formed by a sound collecting port of the second microphone and a vibrating surface of the speaker unit is 30 degrees or more.

5. The speaker device according to claim 1, wherein
the speaker unit is stored in an enclosure, and
the first microphone and the second microphone are respectively arranged in a member connected to the enclosure.

6. The speaker device according to claim 1, wherein
a vibrating surface of the speaker unit includes an insulating member and a plurality of metal films arranged in a part of a surface of the insulating member,
the speaker unit includes a coil arranged on the vibrating surface, and
a terminal of the coil is electrically connected to the metal film.

7. The speaker device according to claim 1, further comprising:
a signal processing circuit configured to be input with a first sound signal showing an input sound to the first microphone and a second sound signal showing an input sound to the second microphone, configured to execute signal processing using a correlation relationship between the first sound signal and the second sound signal, configured to output a sound collecting signal generated by the signal processing, configured to be input with a third sound signal for driving the speaker unit, and configured to output a drive signal for driving the speaker unit based on the third sound signal.

8. The speaker device according to claim 7, wherein
the signal processing circuit is configured to be input with a third sound signal for driving the speaker unit, is configured to output a drive signal for driving the speaker unit based on the third sound signal, and is configured to output a sound collecting signal by signal processing using the correlation relationship and the third sound signal.

9. The speaker device according to claim 7, further comprising:
an input/output terminal configured to be input with a digital signal and output a digital signal;
wherein
a third sound signal for driving the speaker unit is input to the input/output terminal, and
the sound collecting signal is output from the input/output terminal.

10. The speaker device according to claim 9, wherein
the signal processing circuit includes an input buffer configured to temporarily store the third sound signal input from the input/output terminal, and an output buffer configured to temporarily store a sound collecting signal output from the input/output terminal.

11. The speaker device according to claim 7, wherein
the signal processing circuit includes a ΔΣ modulator and a filter, the ΔΣ modulator is configured to be input with a third sound signal for driving the speaker unit and is configured to modulate a digital signal of n bits, and the filter is configured to convert the digital signal of n bits to a plurality of the drive signals.

12. The speaker device according to claim 11, wherein
a vibrating surface of the speaker unit includes an insulating surface and a plurality of metal films arranged in the insulating surface,
the speaker unit includes a plurality of coils arranged in the vibrating surface,
a terminal of the coil is electrically connected to the metal film, and
each of the plurality of drive signals is supplied to each coil respectively via the metal film.

13. The speaker device according to claim 6, wherein
the metal film and the terminal of the coil are electrically connected in an inner periphery side of the coil.

14. The speaker device according to claim 6, wherein
a vibrating surface of the speaker unit includes a heat dissipation film arranged in a position contacting the coil and not contacting the terminal of the coil.

15. A speaker unit comprising:
a vibrating surface including an insulating surface;
a plurality of metal films arranged on the insulating surface; and
a coil arranged on the vibrating surface and including a terminal electrically connected to the metal film.

16. The speaker unit according to claim 15, wherein
the metal film and the terminal of the coil are electrically connected in an inner periphery side of the coil.

17. The speaker unit according to claim 15, wherein
the vibrating surface includes a heat dissipation film arranged in a position contacting the coil in region other than the terminal of the coil.

18. The speaker unit according to claim 15, wherein
a plurality of the coils is arranged on the vibrating surface.

19. A speaker device comprising:
a microphone;
a speaker unit including a vibrating surface; and
a signal processing circuit configured to be input with a third sound signal for driving the speaker unit, configured to output a drive signal for driving the speaker unit based on the third sound signal, configured to be input with a first sound signal showing an input signal to the microphone, and configured to output a sound collecting signal by signal processing using the third sound signal with respect to the first sound signal.

20. The speaker device according to claim 19, further comprising:
an input/output terminal configured to be input with a digital signal and output a digital signal;
wherein
the third sound signal is input to the input/output terminal,
the sound collecting signal is output from the input/output terminal,
the signal processing circuit includes an input buffer configured to temporarily store the third sound signal input from the input/output terminal, and an output buffer configured to temporarily store a sound collecting signal output from the input/output terminal.

21. A speaker device comprising:
a plurality of microphones including at least a first microphone and a second microphone; and
a plurality of speaker units including at least a first speaker unit and a second speaker unit each having a vibrating surface, a distance from the first microphone with respect to a predetermined position between the vibrating surface of the first speaker unit and the vibrating surface of the second speaker unit being equal to a distance from the second microphone with respect to the predetermined position.

22. The speaker device according to claim 21, wherein
the first speaker unit and the second speaker unit are driven by the same signal.
